(19) United States
(12) Patent Application Publication
(10) Pub. No.: US 2009/0046749 A1
(43) Pub. Date: Feb. 19, 2009

(54) COHERENT LIGHT SOURCE

(76) Inventor: Kiminori Mizuuchi, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/659,133

(22) PCT Filed: Aug. 3, 2005
(86) PCT No.: PCT/JP2005/014203

§ 371 Date: Oct. 1, 2008

(30) Foreign Application Priority Data
Aug. 4, 2004 (JP) 2004-227922

(51) Int. Cl. H01S 3/10

(52) U.S. Cl. 372/22

(57) ABSTRACT

A coherent light source is provided with a light source unit for projecting a fundamental wave having a first wavelength, and a wavelength converting unit for projecting a second harmonic wave of the fundamental wave at a prescribed average power or more by receiving the fundamental wave. The coherent light source suppresses generation of sum frequency of the second harmonic wave and the fundamental wave, which causes unstable power. Therefore, a constitution is provided for keeping a walk-off angle of the fundamental wave and SFG light at 15 degrees or higher.

### TECHNICAL FIELD

The present invention relates to a coherent light source and particularly to a coherent light source including a wavelength conversion element which allows light having a wavelength different from the wavelength of received light to exit by receiving light and converting the wavelength of the light.

### BACKGROUND ART

With respect to a coherent light source, in recent years, wavelength conversion technology of light has been developed continuously, and consequently a coherent light source becomes highly efficient and high-powered. For example, as a method of realizing a highly efficient coherent light source, there are known a method of improving conversion efficiency of a wavelength by enhancing a power density of a fundamental wave using an internal resonator, and a method of improving conversion efficiency of a wavelength by using a fundamental wave having a high spiry peak value by a Q switch pulse. Both methods realize a highly efficient conversion of about 50%. For example, by using light having a wavelength close to 1064 nm as a fundamental wave, the generation of green light having a wavelength close to 532 nm, which is a second harmonic (hereinafter, also referred to as “SHG”) of the fundamental wave, is realized.

If a wavelength conversion element is constructed using a material having high conversion efficiency, the second harmonic generation can be performed with high efficiency. Thus, in order to realize highly efficient second harmonic generation, it is desired to further improve the conversion efficiency of nonlinear materials which perform the wavelength conversion.

In order to generate the visible light not only with high efficiency but also at a high-power, that is, in order to generate a second harmonic having a wavelength in a visible light region at a high-power, it is desired that nonlinear materials composing the wavelength conversion element not only have high conversion efficiency but also have excellent resistance in a wavelength region close to a wavelength which the generated second harmonic has. The reason for this is that it may become difficult to attain a desired output stably if nonlinear materials are subjected to optical damage or the like from an electromagnetic wave, such as the second harmonic, propagating within the wavelength conversion unit and has a high-power.

In recent years, Mg doped LiNbO3 (hereinafter, Mg doped LiNbO3 (MgO:LiNbO3) is also referred to as “MgLN”) including a periodical polarization reversal structure in a crystal receives attention as a highly efficient nonlinear material for generating visible light.

MgLN is known to be an inorganic material having the highest nonlinearity for light with a wavelength in a visible light region and to have excellent resistant strength to optical damage. Therefore, it is said that MgLN is suitable for enhancing efficiency and output of a light source. Further advantageously, in MgLN, since crystal growth is easily achieved, cost reduction is possible. And, conventionally, phase matching that utilizes the high nonlinearity of MgLN has been difficult, but a method of forming a periodical polarization reversal structure in MgLN and the like has been developed, and thereby the way is prepared for using MgLN as a highly efficient nonlinear material. Patent Document 1 (Japanese Patent Laid-Open Publication No. H6-242478) discloses a blue light coherent light source using MgLN provided with a periodic polarization reversal structure (hereinafter, also referred to as “PPMgLN (Periodically Poled MgO:LiNbO3)”) as an internal resonator.

And, Non-Patent Document 1 (Y. Furukawa, K. Kitamura, A. Alexandrovski, R. K. Route, and M. M. Fejer, G. Foulon, “Green-induced Infrared absorption in MgO doped LiNbO3”, Applied Physics Letters, US, American Institute of Physics, Apr. 2, 2001, vol. 78, p. 1970-1972) reports a phenomenon in which Green induced infrared absorption (GRIIRA) increases in MgLN doped with Mg in an amount of 4.8 mol % or less.

Light of from blue light having a wavelength close to 450 nm to green light having a wavelength close to 530 nm can be produced by performing wavelength conversion using a nonlinear optical crystal prepared by crystal growth of the above-mentioned nonlinear materials as a wavelength conversion element. By using high-power exiting light emitted from a light source as a fundamental wave and converting this exiting light to a second harmonic by a nonlinear optical crystal having high conversion efficiency, the highly efficient wavelength conversion is realized and a high-power and highly efficient coherent light source of visible light is realized.

In a coherent light source required to have a high-power, it is desired to use materials which are adequately stable in a wavelength region of the fundamental wave and the second harmonic (SHG) for the wavelength conversion element which is used as a wavelength conversion unit. If using a material having a factor where optical characteristics which is destabilized by receiving light in a wavelength region which includes a wavelength of SHG as a wavelength conversion element, stable generation of SHG cannot be performed. Such a material is unsuitable for a wavelength conversion element.

Heretofore, phenomena and causes in which nonlinear materials are destabilized by light in a visible light region, particularly light with a short wavelength of visible light are reported. For example, as for LiNbO3 (hereinafter, also referred to as “LN”) and LiTaO3 (hereinafter, also referred to as “LT”), which are nonlinear materials, (1) optical damage, (2) GRIIRA (infrared absorption induced by green light), and (3) optical destruction are reported. Hereinafter, these will be described.

(1) Optical Damage

Optical damage refers to a phenomenon of changes in a refractive index induced by light. For example, in an LN crystal, its refractive index varies by irradiating the above-mentioned light with a short wavelength. In the wavelength conversion element, when the optical damage occurs, a phase matching condition is not satisfied in the portion of the optical damage, resulting in reduction in conversion efficiency of the element. This phenomenon is a reversible phenomenon and the changed refractive index returns to the original value if the irradiation of light is ceased. The optical damage depends on the wavelength and the intensity of light but in an LN crystal formed by adding Mg in an amount of about 5 mol % or more, the optical damage is not observed.

(2) GRIIRA

This phenomenon arises when green light or blue light and infrared light coexist. For example, if visible light is irradiated to the LN crystal, the absorption of infrared light increases. This phenomenon is a reversible phenomenon, and when the irradiation of visible light is ceased, the absorption decreases. In MgLN doped with Mg in an amount of 4.8 mol % or less, a phenomenon in which the absorption of infrared light increases due to green light has been observed and reported as reported in Non-Patent Document 1.

(3) Optical Destruction

This is a phenomenon in which a crystal is broken by optical energy. The optical destruction exists in any material, and this phenomenon occurs in relation to the power density of light. For example, as for light with a wavelength of 1.064 micrometers (1064 nm), the optical damage in LN and MgLN occurs at a power density of about 100 to 200 MW/square centimeter or more. Since the optical destruction is a phenomenon in which a crystal is destroyed, it is an irreversible phenomenon. However, since the optical destruction only occurs at a high power density of light, problems due to this phenomenon do not become obvious when only light having a power density of the level at which the optical destruction does not occur is used. However, in a coherent light source which a high-power output is required, this problem may become obvious. Therefore, it is desired to realize a light source which generates high-power light stably using a material resistant to optical destruction as a wavelength conversion element. Optical destruction phenomenon does exist in any crystal. The resistance of a crystal to optical destruction is defined by the minimum value of a power density of light which causes crystal destruction.

And, in LN, LT or the like, both of optical damage and GRIIRA occur by light of a relatively low power. Therefore, it is difficult to constitute a light source which produces visible light of high-power using LN, LT or the like. In order to realize such the light source, for example, to attain an output larger than 1 W, a crystal temperature needs to be heated to a temperature of 100 degrees Celsius or higher. In short, if we try to construct a configuration of a light source which stably converts visible light of high-power employing LN, LT or the like as a wavelength conversion element, a problem of stability of a light source due to phenomena such as optical damage etc. associated with this configuration will arise.

And, in KTiOPO4 (hereinafter, also referred to as “KTP”), a phenomenon referred to as a “gray track” in which a color center is produced in a crystal by irradiating visible light with a short wavelength is known. This phenomenon becomes a factor which limits the power of light to be converted when KTP is used as a wavelength conversion element.

And, MgLN and MgLT are materials which receive attention as highly nonlinear materials having excellent resistance to visible light. PPMgLN which has the periodic polarization reversal structure is a nonlinear material having high conversion efficiency and excellent resistant strength to optical damage and can be used for various applications such as an internal resonator structure. And, as for GRIIRA, the PPMgLN does not cause a GRIIRA phenomenon being practically controversial if PPMgLN is doped with Mg in an amount of 5 mol % or more. In fact, as stated above, it is used as a wavelength conversion element of an internal resonator type at an output of 1 W or less.

Patent Document 1: Japanese Patent Laid-Open Publication No. H6-242478.

Non-Patent Document 1: Y. Furukawa, K. Kitamura, A. Alexandrovski, R. K. Route, and M. M. Fejer, G. Foulon, “Green-induced Infrared absorption in MgO doped LiNbO3”, Applied Physics Letters, US, American Institute of Physics, 2nd, Apr. 2001, vol. 78, pages 1970-1972.

### DISCLOSURE OF INVENTION

### Problem to be Solved by the Invention

As described above, MgO—LiNbO3 (MgLN) and MgO—LiTaO3 (MgLN) are highly nonlinear materials having excellent resistant strength to the optical damage. Actually, in PPMgLN, stable high-power wavelength conversion can be performed even in wavelength conversion at temperatures close to room temperature. However, the inventor of the present application found a phenomenon in which an output is destabilized when a fundamental wave having a high peak power is irradiated to a crystal or the like (PPMgLN or the like) having a periodical polarization reversal structure or visible light is produced at a high-power. For example, as for PPMgLN, the inventor of the present application observed a phenomenon of the output to be destabilized, which is assumed to arise due to causes other than the optical damage, in the conversion of a high output of 1 watt or more. Such a phenomenon of being destabilized is a factor which makes the stability of a light source doubtful when constructing a high-power coherent light source using PPMgLN or the like as a wavelength conversion element. If measures are not taken against this phenomenon, reliability of a light source will be significantly impaired. It is an object of the present invention to provide a coherent light source which can output stably at a high-power by determining the cause of this phenomenon of an output to be destabilized and presenting measures to avoid this phenomenon.

### Means for Solving Problem

The present invention, in an aspect of the present invention, pertains to a coherent light source having a light source unit which allows a fundamental wave having a first wavelength of 1070 nm or longer to exit and a wavelength conversion unit which receives the fundamental wave and allows a second harmonic of the fundamental wave to exit at a prescribed or higher average output.

In the aspect of the present invention, the wavelength conversion unit preferably has Mg doped LiNbO3 having a periodical polarization reversal structure.

In the aspect of the present invention, the wavelength conversion unit preferably has Sc doped LiNbO3 having a periodical polarization reversal structure.

In the aspect of the present invention, the wavelength conversion unit preferably has In doped LiNbO3 having a periodical polarization reversal structure.

In the aspect of the present invention, the wavelength conversion unit preferably has Zn doped LiNbO3 having a periodical polarization reversal structure.

The present invention, in another aspect of the present invention, pertains to a coherent light source having a light source unit which allows a fundamental wave having a first wavelength of 1027 nm or longer to exit and a wavelength conversion unit which receives the fundamental wave and allows a second harmonic of the fundamental wave to exit at a prescribed or higher average output, and contains stoichiometric MgO—LiNbO3, having a periodical polarization reversal structure.

The present invention, in a further aspect of the present invention, pertains to a coherent light source having a light source unit which allows a fundamental wave having a first wavelength of 1018 nm or longer to exit and a wavelength conversion unit which receives the fundamental wave and allows a second harmonic of the fundamental wave to exit at a prescribed or higher average output, and contains LiTaO3 having a periodical polarization reversal structure.

The present invention, in a yet further aspect of the present invention, pertains to a coherent light source having a light source unit which allows a fundamental wave having a first wavelength of 850 nm or longer to exit and a wavelength conversion unit which receives the fundamental wave and allows a second harmonic of the fundamental wave to exit at a prescribed or higher average output, and contains KTiOPO4 having a periodical polarization reversal structure.

In each aspect of the present invention, it is preferred to further have an ultraviolet light shielding unit which covers at least a part of the wavelength conversion unit to protect the wavelength conversion unit from light with a wavelength of 400 nm or shorter entering from the outside.

The present invention, in other aspect of the present invention, pertains to a coherent light source having a light source unit which allows a fundamental wave having a first wavelength of 800 nm or longer to exit, a wavelength conversion unit which receives the fundamental wave and allows a light having a second wavelength which is one-half wavelength of the first wavelength to exit at a prescribed or higher average output, and an ultraviolet light shielding unit which covers at least a part of the wavelength conversion unit to protect the wavelength conversion unit from light with a wavelength of 400 nm or shorter entering from the outside.

In each aspect of the present invention, it is preferred to operate the wavelength conversion unit at a temperature of 100 degrees Celsius or lower.

In each aspect of the present invention, it is preferred that a polarization reversal angle, which is an angle formed by a normal of a stripe exhibited by the periodical polarization reversal structure of the wavelength conversion unit with a traveling direction of the fundamental wave, is an angle of 3 degrees or larger.

In each aspect of the present invention, it is preferred that the wavelength conversion unit has a crystal structure and an angle which is formed by a stripe exhibited by the periodical polarization reversal structure with the direction perpendicular to an a-axis and a c-axis of the crystal structure is larger than an angle of 0 degree and not more than an angle of 1 degree.

The present invention, in an aspect of the present invention, pertains to a coherent light source having a light source unit which allows a fundamental wave having a prescribed first wavelength to exit and a wavelength conversion unit having a periodical polarization reversal structure, which receives the fundamental wave and allows a second harmonic of the fundamental wave to exit at a prescribed or higher average output, wherein a polarization reversal angle, which is an angle formed by a normal of a stripe exhibited by the periodical polarization reversal structure included in the wavelength conversion unit with a traveling direction of the fundamental wave, is an angle of 3 degrees or larger.

In an aspect of the present invention, it is preferred that the wavelength conversion unit has a crystal structure and an angle which is formed by a stripe exhibited by the periodical polarization reversal structure with the direction perpendicular to an a-axis and a c-axis of the crystal structure is larger than an angle of 0 degree and not more than an angle of 1 degree.

In each aspect of the present invention, it is preferred to further have an electrode unit located in such a way that a current can be passed through the wavelength conversion unit and a power supply unit to apply a voltage to the electrodes.

In each aspect of the present invention, it is preferred that the light source unit has a fiber laser.

In each aspect of the present invention, it is preferred that the light source unit is pulse-driven by a Q switch and its cyclic frequency is preferably 1 kHz or higher.

In each aspect of the present invention, it is preferred that a prescribed average output of the second harmonic in the wavelength conversion unit is 1 watt or more.

In each aspect of the present invention, it is more preferred that a prescribed average output of the second harmonic in the wavelength conversion unit is 2 watts or more.

In each aspect of the present invention, it is further preferred that a prescribed average output of the second harmonic in the wavelength conversion unit is 2.5 watts or more.

In each aspect of the present invention, it is furthermore preferred that a prescribed average output of the second harmonic in the wavelength conversion unit is 3 watts or more.

### EFFECT OF THE INVENTION

The present invention provides a high-power coherent light source in a visible light region using a wavelength conversion element. The coherent light source in accordance with the present invention does not have the problems in output instability at a high output and reliability and has a stable output characteristic.

### BRIEF DESCRIPTION OF DRAWINGS

FIG. 1 is a diagram of an experimental optical system.

FIG. 2A is a diagram of an experimental optical system.

FIG. 2B is a graph plotting a relationship between light quantities of detected infrared light and irradiated ultraviolet light.

FIG. 3A is a diagram of a fundamental wave, SHG, and SFG which propagate in PPMgLN.

FIG. 3B is a graph plotting a relationship between a fundamental wave wavelength and a walk-off angle between the fundamental wave and SFG in PPMgLN.

FIG. 3C is a graph plotting a relationship between the fundamental wave wavelength and the intensity of SFG in PPMgLN.

FIG. 3D is a graph plotting a relationship between a fundamental wave wavelength and a walk-off angle between the fundamental wave and SFG in PPMgSLN.

FIG. 3E is a graph plotting a relationship between a fundamental wave wavelength and a walk-off angle between the fundamental wave and SFG in PPLT.

FIG. 3F is a graph plotting a relationship between a fundamental wave wavelength and a walk-off angle between the fundamental wave and SFG in PPKTP.

FIG. 4A is a diagram of a coherent light source in accordance with the first embodiment.

FIG. 4B is a diagram of a coherent light source in accordance with the modification example of the first embodiment.

FIG. 5 is a graph plotting a relationship between the fundamental wave wavelength and the resistance at room temperature.

FIG. 6 is a graph plotting crystal temperature dependency of the relationship between the fundamental wave wavelength and the resistance.

FIG. 7 is a graph plotting relationships between SFG intensity and a propagation distance which are produced in a state of quasi-phase matching and a state of phase mismatching.

FIG. 8 is a schematic diagram of a wavelength conversion unit in accordance with the second embodiment.

FIG. 9 is a schematic diagram of a modification example of the wavelength conversion unit in accordance with the second embodiment.

FIG. 10 is a graph plotting a relationship between a polarization reversal angle and the walk-off angle.

FIG. 11 is a graph plotting relationships between the polarization reversal angle and SHG conversion efficiency and between the polarization reversal angle and the resistance of the wavelength conversion element.

FIG. 12 is a diagram of a coherent light source in accordance with the third embodiment.

### EXPLANATIONS OF LETTERS OR NUMERALS

401, 1201 light source
402, 802, 902, 1202 wavelength conversion element
451 ultraviolet light shielding unit
803, 903 polarization reversal structure
1210 power supply
1211 electrode
4 fundamental wave
5 SHG
6 SFG
21 ultraviolet light source
22 light source
23 dichroic mirror
24 PPMgLN
25 infrared light
27 filter
28 PD

### BEST MODE FOR CARRYING OUT THE INVENTION

A coherent light source in accordance with the present invention uses high-power light which a high-power light source unit allows to exit as a fundamental wave, converts this fundamental wave to a second harmonic by a wavelength conversion unit, and allows the converted light to exit. The coherent light source of the present invention is a high-power coherent light source having a light source unit which allows a high-power fundamental wave to exit and a wavelength conversion element which realizes highly efficient wavelength conversion. As described above, it is desired to use materials which are stable (high in resistance) at least in a wavelength region including a fundamental wave to be used and second harmonics (SHG) in order to realize such a high-power coherent light source. Some causes of becoming unstable in material against light with a short wavelength included in a visible light region are well known as described above. It is natural to construct the high-power coherent light source in order to avoid these phenomena in consideration of these well known factors which cause destabilization, but the inventor of the present application found a phenomenon which causes destabilization and which is different from the previous phenomenon. The present invention discloses a coherent light source, which can produce a high output more stably, based on findings regarding the phenomenon found by the inventor of the present application.

The inventor of the present application found a heretofore unobserved phenomenon of destabilization in generating green light (wavelength of 532 nm) having a high output of 1 watt or more using PPMgLN. And, the inventor of the present application found that a phenomenon of the output deterioration of a light source exists when using the light source for a long time. The inventor of the present application reveals the cause of the found phenomenon and discloses a constitution of a high-power coherent light source which does not cause such destabilization and time deterioration in the output.

(Phenomenon of Wavelength Conversion Element to be Destabilized in Wavelength Conversion of High-Power Light)

First, the newly found phenomenon will be described taking PPMgLN as an example.

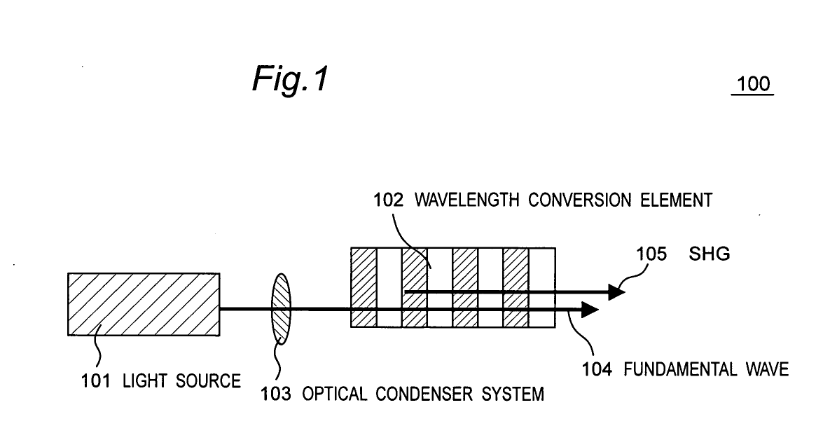

The inventor of the present application conducted a wavelength conversion experiment using an optical system 100 shown in FIG. 1 for 5 mol % Mg doped PPMgLN. The optical system 100 has a light source 101, a wavelength conversion element 102, and an optical system 103 for condensing light. The light source 101 is a laser light source using neodymium (Nd) doped YVO4 as a solid-state laser and generates laser light with a wavelength of 1064 nm by semiconductor laser excitation. And, the light source 101 is constructed in such a way that an AO switch is inserted into a resonator of a solid-state laser and a pulse row having a high spiry peak value is generated by a Q switch. The wavelength conversion element 102 includes 5 mol % Mg doped PPMgLN and has a polarization reversal structure with a period of 6.95 micrometers, and the length of the element is 10 mm. Light with a wavelength of 1064 nm emitted by the light source 101 is used as a fundamental wave 104. The fundamental wave 104 enters the wavelength conversion element 102 and is converted to SHG 105 with a wavelength of 532 nm. The fundamental wave 104 is generated as a pulse row as described above and its average power can be brought into several watts. The fundamental wave 104 may be condensed by a condensing lens composing the optical system 103 for condensing light and may be converted by the wavelength conversion element 102. Conversion efficiency of this wavelength conversion is around 50%.

When a power of a fundamental wave was increased and the fundamental wave 104 having a power of about 2 watts was inputted, the output of SHG 105 was destabilized and the conversion efficiency was dropped from 50% to about 40%. The average output of the fundamental wave 104 at this time was about 2 watts and the intensity of pulsed light was 60 MW/square centimeter at the maximum.

Further, when the power of the fundamental wave 104 was increased and the intensity of pulsed light reached about 80 MW/square centimeter of the maximum value, the conversion efficiency was further decreased and the deterioration of quality of the beam exited was also observed.

The inventor of the present application made investigations concerning the causes of reducing of the output of SHG 105, and consequently found that ultraviolet light with a wavelength of 355 nm (not shown) exits the wavelength conversion element 102 (PPMgLN) besides SHG 105 with a wavelength of 532 nm. The generation of ultraviolet light was observed in a fundamental wave intensity region where the above-mentioned reduction in conversion efficiency of SHG 105 arises. And, it become apparent that propagating directions of SHG 105 observed and ultraviolet light (not shown), namely, the directions which pointing vectors direct are slightly deviated from each other and these light are generated at different output angles.

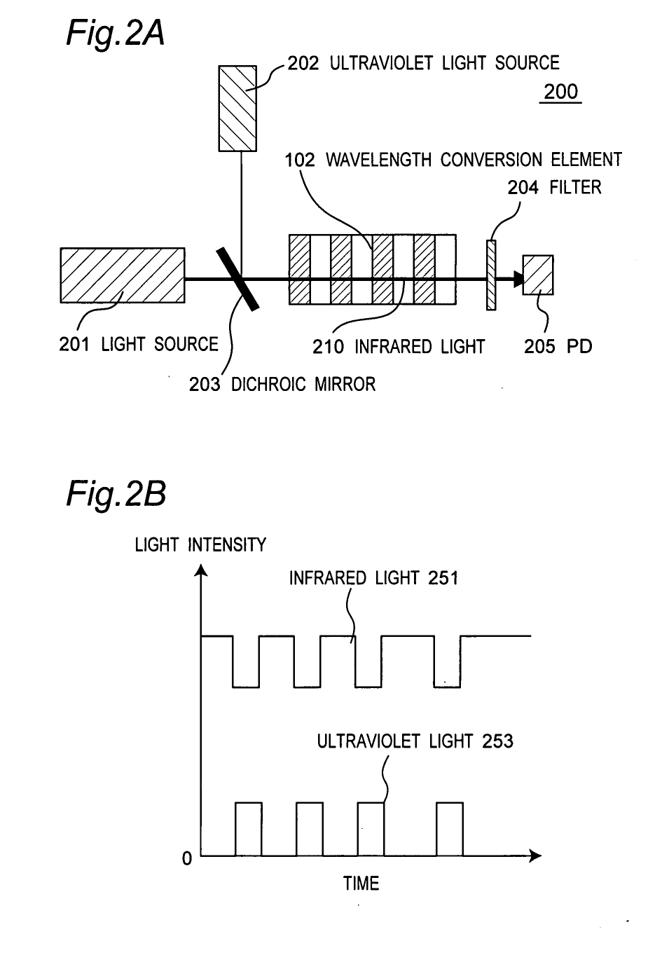

Therefore, the inventor of the present application investigated influences of ultraviolet light (wavelength of 355 nm) on PPMgLN. An optical system 200 used in this investigation is shown in FIG. 2A. The optical system 200 has two kinds of light sources of a light source 201 and an ultraviolet light source 202, a dichroic mirror 203, the wavelength conversion element 102 (PPMgLN), a filter 204, and a photodetector (PD) 205. The light source 201 is a light source emitting light (infrared light 210) having a prescribed wavelength in an infrared region and the ultraviolet light source 202 is a light source emitting light (ultraviolet light) having a prescribed wavelength (for example, 355 nm) in an ultraviolet region. The light emitted by both light sources 201 and 202 is multiplexed by the dichroic mirror 203 and enters the wavelength conversion element 102 (PPMgLN). The filter 204 allows the light exited by the wavelength conversion element 102 to selectively pass through the filter and separates wavelengths and infrared light 210 passing through the filter 204 is detected by the PD 205.

The light sources 201 allows the infrared light 210 to exit continuously and the ultraviolet light source 202 allows the ultraviolet light to exit while performing intensity modulation. FIG. 2B is a graph on which a relationship between the intensity of ultraviolet light which the ultraviolet light source 202 allows to exit and the intensity of infrared light 210 detected at the PD 205 are plotted. The lateral axis indicates a time and the vertical axis indicates the intensity of light. Incidentally, a ratio between the intensity 251 of infrared light 210 and the intensity 253 of ultraviolet light is not particularly important. The graph is plotted disregarding a scale in favor of clarity. Here, as an important matter, there is the correlation between a time period during which the intensity 253 of ultraviolet light indicates a value of non-zero and a time period during which the intensity 251 of infrared light 210 becomes relatively low. A power of ultraviolet light used actually in an experiment was about several milliwatts, but it is apparent that the intensity of infrared light 210 exiting the wavelength conversion element 102 decreases as ultraviolet light is irradiated.

The relationship between the wavelength of ultraviolet light and the absorbed quantity of infrared light was observed and consequently it is evident that the absorption of infrared light increases by the irradiation of ultraviolet light having particularly a wavelength of about 320 nm to 400 nm. The absorption of visible light did not occur for ultraviolet light having a wavelength of 400 nm or longer. And, in the irradiation of ultraviolet light having a wavelength of 320 nm to 400 nm, if the wavelength of ultraviolet light is short, the absorption of visible light occurred even though the power of ultraviolet light irradiated is low. But, the absorption of infrared light did not occur by the irradiation of ultraviolet light (ultraviolet rays) having a wavelength of 320 nm or shorter. The reason for this is assumed that since 320 nm is an absorbing end of MgLN, ultraviolet light is almost absorbed at the surface of a crystal and an influence on an absorbed quantity of infrared rays hardly appears.

Further, though the results are not shown, the absorption of visible light by the wavelength conversion element 102 which received the irradiation of ultraviolet light was measured similarly and consequently it was found that the absorption of visible light by the wavelength conversion element 102 due to the irradiation of ultraviolet light was more remarkable than the absorption of infrared light. The reason for this is thought that the absorbed quantity of visible light by the wavelength conversion element 102 is increased due to the irradiation of ultraviolet light. In MgLN containing Mg in an amount of 5 mol % or more, the absorption of visible light by the irradiation of such light with a short wavelength (for example, ultraviolet light) was discovered.

Based on the above-mentioned experimental results, the causes of destabilization of an output generated of SHG in a visible light region in PPMgLN will be described.

Referring to FIG. 1 again, in PPMgLN (wavelength conversion element 102), the phenomenon of an output to be destabilized of SHG 105 generation arises because SFG (not shown) in an ultraviolet region having a wavelength of 355 nm which is a sum frequency of a wavelength of 1064 nm and a wavelength of 532 nm is generated, for example, when a fundamental wave 104 with a wavelength of 1064 nm is converted to SHG 105 with a wavelength of 532 nm. It is thought that by the generation of SFG in an ultraviolet region, the absorption of visible light increases, a thermal lens effect in which a temperature within a crystal (PPMgLN) partially increases arises, and a state of phase matching is destabilized. As shown by the above-mentioned experimental results, when ultraviolet light having a wavelength of 400 nm or shorter is irradiated to the wavelength conversion element 102 generating visible light (for example, SHG 105) at an output of 1 watt or more, this becomes a factor causing that the absorption of visible light increases, a thermal lens effect arises, and an output of the wavelength conversion element 102 varies. When the output of the harmonic is small, the extent of temperature increase in the wavelength conversion element 102 by the absorption is small even if the absorption occurs, and a thermal lens effect does not arise. But, when the output of the harmonic (for example, SHG 105) exceeds about 1 watt, the extent of temperature increase by the absorption of the harmonic increases, a thermal lens effect arises, and an output is destabilized. Not only ultraviolet light generated within the wavelength conversion element 102 but also ultraviolet light irradiated from the outside of the wavelength conversion element 102 causes such harmonic output instability. Even when a power of ultraviolet light generated within the wavelength conversion element 102 or irradiated from the outside is relatively low, the absorption of visible light increases. Therefore, the wavelength conversion element 102 is preferably protected by an ultraviolet light shielding unit so that ultraviolet light does not enter from the outside of the element 102. This ultraviolet light shielding unit desirably shields the light having a wavelength of 400 nm or shorter and protects the element 102. The ultraviolet light shielding unit desirably has a high ability of shielding (non-transparency) to at least a light having a wavelength of 320 nm or longer and 400 nm or shorter.

Even when the wavelength conversion element 102 is in a state of almost completely shielding ultraviolet light entering the element 102 from the outside by providing the ultraviolet light shielding unit, the phenomenon of an output to be destabilized was observed if an output of the harmonics (for example, SHG) was increased. The reason for this is that ultraviolet light generated within a substrate of the wavelength conversion element 102 exists.

However, for generating SFG of a measurable level, that is, for performing the wavelength conversion to SFG with high efficiency, it is necessary to satisfy prescribed phase matching conditions. It is difficult to think that highly efficient wavelength conversion of SFG, which uses a wavelength different from an aimed wavelength, readily occurs from the stage of element design in the same element.

And so, another experiments were carried out on a phenomenon in which an output of SHG is destabilized to attain the following fundamental wave wavelength dependency on the development of a phenomenon of SHG output to be destabilized.

(Fundamental Wave Wavelength Dependency of Absorbing Rate of Visible Light)

When the wavelength of the fundamental wave was included in a range of 1030 nm or shorter, the resistance was high and a phenomenon of an output to be destabilized did not occur even when an average output of SHG was increased to several watts (power density: several MW/square centimeter or more).

However, when the wavelength of the fundamental wave was included in a range of 1030 nm to 1050 nm, destabilized SHG output took place at a low power output at which an average output of SHG was limited below several hundreds milliwatts. Further, the instability of the output was increased even at a low power of about several kW/square centimeter in a power density.

But, when the wavelength of the fundamental wave was included in a range of 1060 nm to 1100 nm, a phenomenon of an output to be destabilized did not occur even when an average output of SHG was increased to several watts. There was an improvement in the resistance compared with the above range of 1030 nm to 1050 nm.

The states of ultraviolet light generation in irradiating the fundamental wave having a wavelength included in the above-mentioned respective ranges were observed. Consequently, when the fundamental wave having a wavelength of 1030 nm to 1050 nm was irradiated, the generation of ultraviolet light was remarkable and the intensity of ultraviolet light further increased as the wavelength of the fundamental wave approached 1030 nm. Also, when the fundamental wave having a wavelength of 1060 nm to 1100 nm was irradiated, the generation of ultraviolet light was slightly observed. But, the generation of ultraviolet light was not observed in a range of 1030 nm or shorter and a range of 1100 nm or longer.

From the above-mentioned results, it is shown that the resistance to a phenomenon of SHG output to be destabilized depends on the intensity of ultraviolet light generated (for example, SFG generated), and the fundamental wave wavelength dependency on the resistance results from that the intensity of ultraviolet light generated depends on the fundamental wave wavelength.

(Determination of Mechanism of Ultraviolet Light Generation and Suppression of Ultraviolet Light Generation)

And so, in order to reveal the cause of ultraviolet light generation in PPMgLN, phase matching characteristics were analyzed. It is necessary that a non-critical quasi-phase matching condition holds in PPMgLN for generating SFG with high efficiency. And, even when the non-critical quasi-phase matching condition does not perfectly holds, the quasi-phase matching condition may hold by propagating the fundamental wave and SFG in the different directions at a walk-off angle of non zero. When this walk-off angle becomes small, SFG increases sharply. And, when the walk-off angle becomes 0 degree angle and the fundamental wave and SFG travel in the same direction, this corresponds to the case where a non-critical quasi-phase matching condition holds.

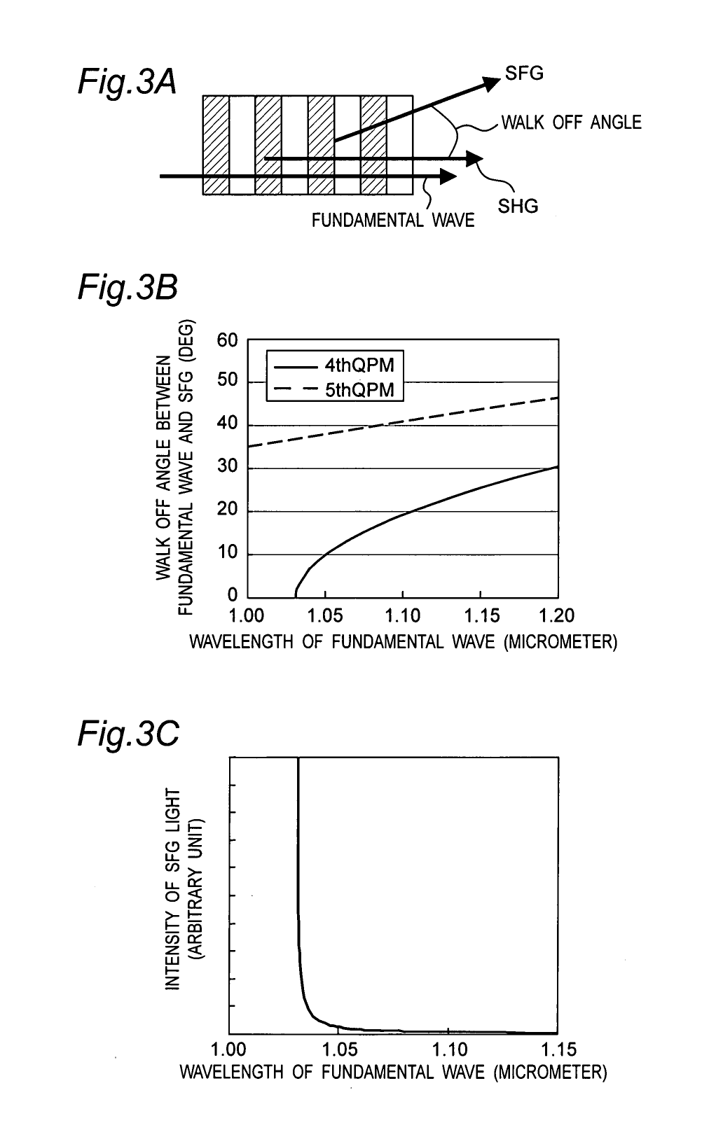

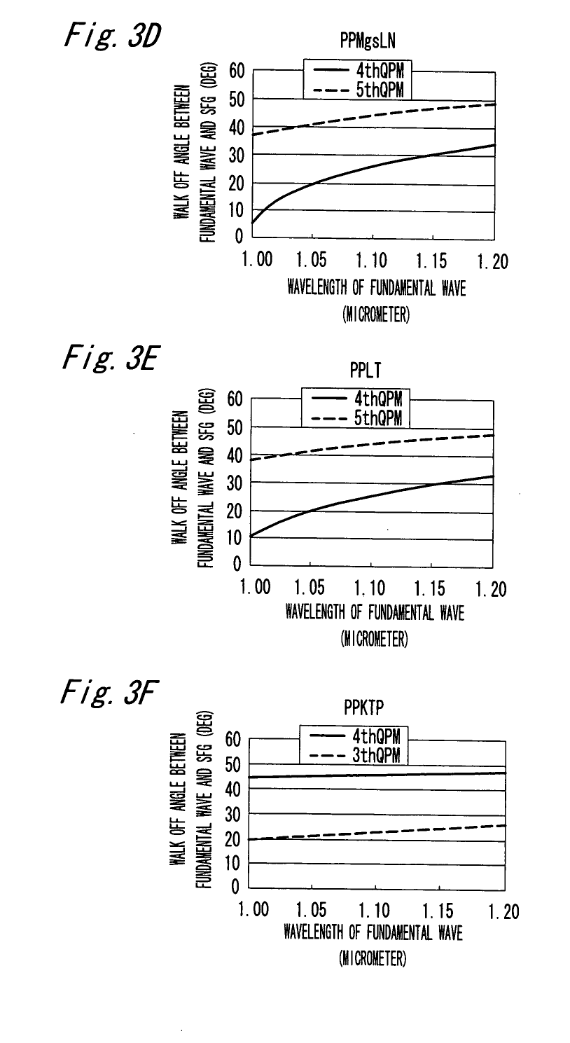

When SHG is generated in the coherent light source, it is desirable to find the conditions in which SFG is not generated and generate SHG under such conditions for inhibiting SFG generation and stabilizing the output of SHG. FIG. 3A is a diagram showing a walk-off angle of SFG generated. The arrow shows the propagating direction of light, and in this figure, the walk-off angle refers to an angle which the arrow showing the propagating direction of SFG forms with the arrow showing the propagating direction of SHG. That is, this walk-off angle is an angle which is formed by a pointing vector of SFG with a pointing vector of SHG.

PPMgLN needs to include a periodical polarization reversal structure with a period of about 6.95 micrometers so that wavelength conversion by PPMgLN is performed and a phase matching condition to generate SHG with a wavelength of 532 nm from the light (fundamental wave) with a wavelength of 1064 nm holds. This value is calculated from the variance of refractive index of MgLN. On the other hand, light having a wavelength of 355 nm is generated by a sum frequency (SFG) of a fundamental wave with a wavelength of 1064 nm and SHG light with a wavelength of 532 nm. PPMgLN needs to include a periodical polarization reversal structure with a period of about 1.79 micrometers so that SFG is generated with high efficiency. A polarization reversal period of 6.95 micrometers suitable for generating SHG from the fundamental wave does not satisfy a polarization reversal period of 1.79 micrometers suitable for generating the sum frequency of the fundamental wave and SHG. But, there is a possibility that phase matching occurs in a periodical structure of higher order. If the periodical polarization reversal structure is an integral multiple (m times) of 1.79 micrometers, it is possible to perform the phase matching and generate the sum frequency (SFG) with high efficiency. (However, in this case, the conversion efficiency decreases in proportion to 1/(square meter).)

So, a possibility of phase matching by a periodical polarization reversal structure of high order was calculated, and consequently it was evident that there were phase matching characteristics shown in FIGS. 3B and 3C. FIG. 3A indicates that the fundamental wave and SHG perform non-critical phase matching (SHG generation in PPMgLN can be made highly efficient by performing non-critical phase matching in which the fundamental wave and SHG propagate in the same direction). In this case, as shown in FIG. 3B, when the wavelength of the fundamental wave is included in a range of 1000 nm to 1200 nm, SFG (wavelength lambda/3) of the fundamental wave (wavelength lambda) and SHG (wavelength lambda/2) is generated by quaternary and quintic quasi-phase matching (QPM) (abbreviated to 4th QPM and 5th QPM, respectively). However, since SFG by the quintic quasi-phase matching has a large walk-off angle of 30 degrees or larger, an output of SFG (sum frequency) is extremely small and does not have an effect on the resistance. A vertical axis of FIG. 3B is a walk-off angle between SFG and a fundamental wave. When a walk-off angle between a fundamental wave and SHG is an angle of 0 degree, this walk-off angle agrees with the walk-off angle shown in FIG. 3A, but it is noted that in a strict sense, the walk-off angle shown in FIG. 3A is different from the walk-off angle of the vertical axis of FIG. 3B. On the other hand, SFG by the quaternary quasi-phase matching is generated when the wavelength of the fundamental wave is 1030 nm or longer as shown in FIG. 3B. Particularly, in a fundamental wave wavelength close to 1030 nm, the walk-off angle is small and the output of SFG is extensively increased in the vicinity of the fundamental wave wavelength of 1030 nm. This state is shown in FIG. 3C. Referring to FIG. 3C, the output of SFG is extensively increased from the region of the fundamental wave wavelength of about 1050 nm or shorter where a walk-off angle is 10 degrees or less to the region in the vicinity of the fundamental wave wavelength of 1030 nm. This is a cause of that the resistance of the wavelength conversion element has the fundamental wave wavelength dependency. When the fundamental wave wavelength is 1030 nm, the condition of non-critical phase matching, in which SHG is output in the same direction as the fundamental wave, holds, and therefore SFG is extensively increased and simultaneously the resistance of the wavelength conversion element is extensively reduced.

SFG generated by quasi-phase matching of lower order, for example, by tertiary quasi-phase matching also exists in the vicinity of the fundamental wave wavelength of 1370 nm. However, in this case, the wavelength of SFG is 450 nm or longer and there is no influence on the stability of the output of PPMgLN. On the contrary, there is also possibility that the condition of phase matching of higher order (sextic order or more) holds. But, since the conversion efficiency decreases inversely with the square of the order as described above, the phase matching of higher order (sextic order or more) can be neglected in determining the resistance of the wavelength conversion element.

Subjects to be considered in determining the resistance of the wavelength conversion element is mainly SFG of ultraviolet light output by the quaternary quasi-phase matching. As shown in FIG. 3C, SFG having a wavelength in this ultraviolet region increases sharply as the fundamental wave wavelength approaches +1030 nm in the direction of shortening. The noncritical phase matching exists in the vicinity of the fundamental wave wavelength of 1030 nm, but SFG having a not very large walk-off angle is generated in the vicinity of the fundamental wave wavelength of 1050 nm. From these results, it becomes apparent that in a rage of the fundamental wave wavelength of 1030 nm to 1050 nm, SFG exists at the intensity which is measurable in determining the resistance of the wavelength conversion element. That is, it becomes apparent that such generation of SFG increases the absorption of infrared light which is a fundamental wave in the phase matching in PPMgLN and the absorption of visible light which is SHG, results in a partial temperature increase in PPMgLN, and destabilizes a state of phase matching and an output.

Referring to FIG. 3B again, a walk-off angle between SFG generated by quaternary and quintic quasi-phase matching of PPMgLN and a fundamental wave is an angle of 15 degrees or larger when the wavelength of the fundamental wave is 1070 nm or longer. If the walk-off angle is such a large angle, it does not have an effect on an output of SHG. Generally, the wavelength of the fundamental wave used for SHG generation is often 1064 nm. The walk-off angle in this case is an angle of 13 degrees. However, the inventor of the present application has found that it is desirable to use the wavelength of the fundamental wave of 1070 nm or longer for stabilizing the output of SHG. That is, the walk-off angle is desirably 15 degrees or larger.

FIG. 3D is a graph showing a walk-off angle between SFG generated by quaternary and quintic quasi-phase matching of PPMgSLN and a fundamental wave. As with FIG. 3B, the lateral axis is the wavelength of the fundamental wave. From this figure, in PPMgSLN, the walk-off angle is 15 degrees or larger when the wavelength of the fundamental wave is 1027 nm or longer.

FIG. 3E is a graph showing a walk-off angle between SFG generated by quaternary and quintic quasi-phase matching of PPLT (LiTaO3 including a periodical polarization reversal structure) and a fundamental wave. As with FIG. 3B, the lateral axis is the wavelength of the fundamental wave. From this figure, in PPLT, the walk-off angle is 15 degrees or larger when the wavelength of the fundamental wave is 1018 nm or longer.

FIG. 3F is a graph showing a walk-off angle between SFG generated by tertiary and quaternary quasi-phase matching of PPKTP (KTP including a periodical polarization reversal structure) and a fundamental wave. As with FIG. 3B, the lateral axis is the wavelength of the fundamental wave. It was found by mathematical calculation that in PPKTP, the walk-off angle is 15 degrees or larger when the wavelength of the fundamental wave is 850 nm or longer.

Phenomena observed are summarized.

In the second harmonics generation, factors of destabilizing an output are as follows.

F1. Ultraviolet SFG is generated by fundamental wave and SHG.

F2. The absorption of infrared light (fundamental wave) and the absorption of visible light (SHG and the like) are increased by ultraviolet SFG.

F3. A thermal lens effect due to a partial temperature increase by absorption arises within the wavelength conversion element 402.

F4. A state of phase matching is disturbed by a thermal lens effect and an optical output of SHG is destabilized.

On the other hand, generation of SFG (the above-mentioned F1.) destabilizing the generation of the second harmonics (SHG) needs to satisfy the following conditions.

C1. The wavelength of SFG is longer than the absorption end of a crystal (composing the wavelength conversion element). (When it is shorter than the absorption end, generation of SFG is suppressed by the absorption of a crystal.)

C2. SFG is ultraviolet light with a wavelength of 400 nm or shorter.

C3. The walk-off angle between SFG and the fundamental wave is 0 degree or larger and 15 degrees or smaller (more remarkable at a walk-off angle of 10 degrees or smaller).

C4. Further, an absorption coefficient of a nonlinear optical crystal is increased by irradiation of ultraviolet light.

(Absorbed Wavelength Dependency of Phenomenon of an Output to be Destabilized by a Thermal Lens Effect)

The above-mentioned phenomenon of an output to be destabilized by a thermal lens effect is a phenomenon in which the absorption of a fundamental wave and a (second) harmonic thereof occurs due to generation of ultraviolet rays, a thermal lens effect by this absorption arises, and the output is destabilized. As for the occurrence of a thermal lens effect by light-absorption, it was evident that values of a peak power and an average power of light absorbed have large effects, depending on the wavelength of light absorbed. Herein after, each case will be described.

(i) The wavelength of light absorbed is 700 nm or longer:

When reaching about several tens MW/square centimeter in a peak power or about 1 MW/square centimeter in an average power, the output is destabilized by a thermal lens effect.

(ii) The wavelength of light absorbed is 600 nm or shorter:

The destabilization of the output by a thermal lens effect arises from about 0.1 MW/square centimeter in an average power.

The above-mentioned absorption of the fundamental wave corresponds to the case (i). As for a fundamental wave having a relatively long wavelength, since its absorption coefficient is small, a power density at which the thermal lens effect arises is relatively high. Thus, the thermal lens effect by the absorption of the fundamental wave is clearly revealed in the wavelength conversion of pulse light having a large peak power. A thermal lens effect is significantly generated by a spiry peak value of high-power pulse light.

And so, based on such results, the constitution of a coherent light source which can perform SHG generation stably by a wavelength conversion element having a nonlinear optical material will be described.

### FIRST EMBODIMENT

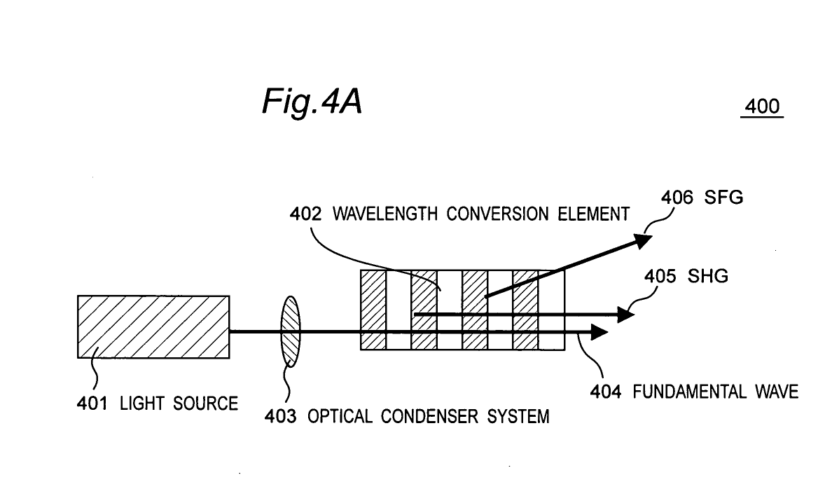

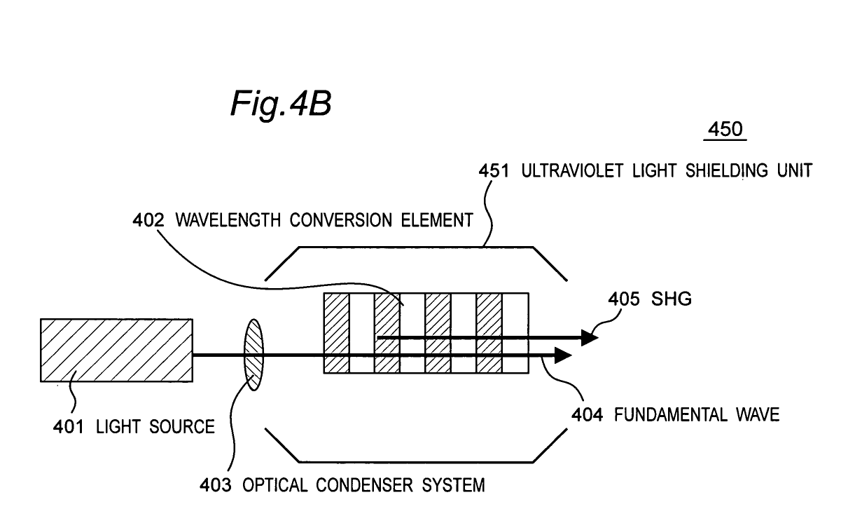

FIG. 4A is a constitution diagram of a coherent light source 400 in accordance with the first embodiment of the present invention. The coherent light source 400 has a light source 401 composing a light source unit and a wavelength conversion element 402 being a wavelength conversion unit. Further, the coherent light source 400 may include an optical system 403 for condensing light being a light-condensing section in such a way that the optical system 403 for condensing light condenses a fundamental wave 404 exiting the light source 401 to the wavelength conversion element 402. The light source 401 can be pulse-driven by a Q switch in order to improve the efficiency of wavelength conversion by the wavelength conversion element 402. The wavelength conversion element 402 includes PPMgLN of a nonlinear optical material. The fundamental wave 404 exiting the light source 401 is condensed within the wavelength conversion element 402 (PPMgLN) by the optical system 403 for condensing light. The wavelength conversion element 402 converts the fundamental wave 404 to SHG 405 in the element 402, and further the fundamental wave 404 and SHG 405 are converted to SFG 406 in the element 402. Here, the wavelength of the fundamental wave 404 is taken as lambda, the wavelength of SHG 405 is taken as lambda/2, and the wavelength of SFG 406 is taken as lambda/3.

### MODIFICATION EXAMPLE

And, FIG. 4B is a constitution diagram of a coherent light source 450 in accordance with the modification example of the first embodiment. The coherent light source 450 further includes an ultraviolet light shielding unit 451 in addition to the constitution of the coherent light source 400 (refer to FIG. 4A). This ultraviolet light shielding unit 451 shields the light having a wavelength of 400 nm or shorter and protects the wavelength conversion element 402. The ultraviolet light shielding unit 451 preferably has high performance of shielding (non-transparency) at least on a light having a wavelength of 320 nm or longer and 400 nm or shorter. The ultraviolet light shielding unit 451 can protect the wavelength conversion element 402 from ultraviolet light by factors producing ultraviolet light existing anywhere such as a fluorescent lamp and sunlight.

By providing the ultraviolet light shielding unit 451, the wavelength conversion element 402 eludes ultraviolet light entering from the outside. The ultraviolet light shielding unit 451 can generate green light (SHG 405) having an output of about 1 watt stably by shielding ultraviolet light from the outside with a cover. And, when the wavelength lambda of a fundamental wave emitted from the light source 401 is 800 nm or longer, the wavelength of SHG thereof is 400 nm or longer. When the fundamental wave wavelength lambda is 800 nm, the wavelength of SFG between the fundamental wave and SHG is approximately 267 nm (lambda/3). Accordingly, ultraviolet light having a wavelength of 320 nm to 400 nm is not generated within the wavelength conversion element 402 and only ultraviolet light entering from the outside has an influence on the increases in the absorption of visible light. Therefore, by adding the ultraviolet light shielding unit 451, the stability of the coherent light source during outputting SHG at a high-power is outstandingly improved.

In addition, the ultraviolet light shielding unit 451 can take not only a structure of covering the wavelength conversion element 402 but also a structure of a thin film formed on the surface of the wavelength conversion element 402 which does not pass ultraviolet light.

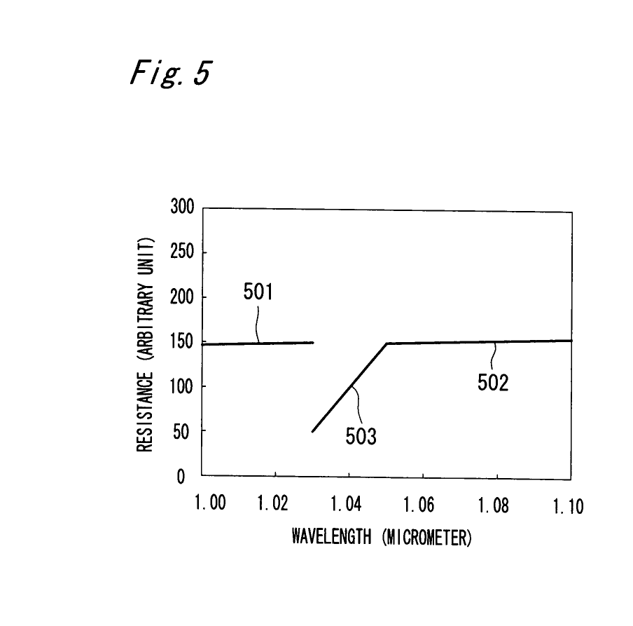

FIG. 5 is a graph showing a relationship between the fundamental wave wavelength lambda and the resistance of a high-power of the wavelength conversion element 402. Here, the light source 401 is pulse-driven at a cyclic frequency of 60 kHz, and a pulse width of each pulse is about 20 ns, and an output characteristic was observed at different fundamental wave wavelengths lambda. The ambient temperature is room temperature.

Referring to FIG. 5, in the fundamental wave wavelength lambda of 800 nm-1000 nm-1030 nm, the resistance of a high-power depends on a wavelength and increases mildly (region 501). In this region, since SFG 406 is generated by quintic quasi-phase matching but a walk-off angle of SFG 406 is kept at 30 degrees or more, the intensity of SFG 406 is very small (refer to FIG. 3B). And, SFG by quaternary quasi-phase matching does not occur because it cannot be phase matched (refer to FIG. 3B). Therefore, the output of SFG 406 is very small and the wavelength conversion element 402 exhibits a high resistance of a high-power.

Thus, the wavelength of a fundamental wave which the light source 401 allows to exit is preferably 1030 nm or shorter.

The same holds true with regard to a range of 1050 nm or longer of the fundamental wave wavelength. When the wavelength of the fundamental wave is 1050 nm or longer, since both of walk-off angles between SFG 406 and the fundamental wave 404, generated by quaternary and quintic quasi-phase matching, are 10 degrees or larger (refer to FIG. 3B), an output of SFG 406 is restricted to a low level (region 505). Accordingly, the wavelength conversion element 402 exhibits a high resistance of a high-power.

Thus, it is also preferred that the wavelength of the fundamental wave which the light source 401 allows to exit is 1050 nm or longer. Further, the wavelength of the fundamental wave is desirably 1070 nm or longer in which a walk-off angle is 15 degrees angle or larger.

On the other hand, in a wavelength range of 1030 nm to 1050 nm (refer to FIG. 3B) in which a walk-off angle is less than 10 degrees angle, the resistance of a high-power is extensively deteriorated (refer to a region 503 in FIG. 5).

Therefore, when the sum frequency (SFG) 406 is generated within the wavelength conversion element 402, if a walk-off angle between SFG 406 and the fundamental wave can be kept preferably at 10 degrees or larger, more preferably at 15 degrees or larger, a coherent light source 400 having a high resistance of a high-power can be realized.

(Influence of a Temperature of Phase Matching on the Resistance of a High-Power)

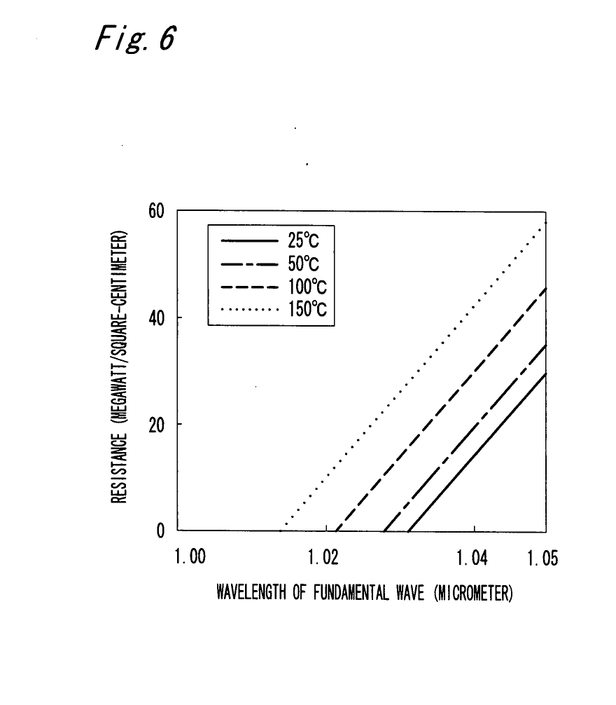

In a wavelength range of 1010 nm to 1030 nm, it is necessary to pay attention to a temperature of phase matching. FIG. 6 is a graph showing the results of measuring the relationship between the fundamental wave wavelength and the resistant strength in the vicinity of the region where SFG 406 is perfectly phase-matched at different temperatures of phase matching. As shown by the region 501 in FIG. 5, in a wavelength range of 1030 nm or shorter, the generation of SFG 406 is inhibited and a strong resistance is exhibited. But, the inventor of the present application found that there is a limited range of crystal temperature for realizing the strong resistance in this fundamental wave wavelength range. Generally, the wavelength conversion element 402 is often used raising a temperature of a crystal above about 100 degrees Celsius in order to decrease the influence of the optical damage and GRIIRA. However, in this fundamental wave wavelength region (1010 nm to 1030 nm), by raising the temperature of a crystal, the wavelength of the fundamental wave, which satisfies a phase matching condition in which SFG 406 is generated, is shifted to the side of a short wavelength. Therefore, SFG 406 is generated and further a walk-off angle between the fundamental wave 404 and SFG 406 is smaller than 10 degrees.

Accordingly, when a temperature is raised, the region (corresponding to the region 503 in FIG. 5) where the resistance is decreased is shifted to the short wavelength side. In other words, as shown in FIG. 6, the shortest fundamental wave wavelength end in a fundamental wave wavelength region where the resistance is reduced is shortened with increases in temperature of the wavelength conversion element.

Therefore, when the wavelength of the fundamental wave is included in a range of 1010 nm to 1030 nm, it is preferred to use the wavelength conversion element keeping a temperature of phase matching at or below 50 degrees Celsius in order to maintain the resistance of a high-power.

Particularly, when the wavelength of the fundamental wave is included in a range of 1020 nm to 1030 nm, it is preferred to use the wavelength conversion element paying close attention to the temperature of a crystal. In this wavelength region, by a slight increase in temperature, the condition of perfect phase matching holds, the intensity of SFG 406 increases sharply, and the resistance of a high-power is significantly deteriorated.

And, when the wavelength of the fundamental wave included in a range of 1020 nm to 1030 nm is used, an ytterbium (Yb) doped YAG solid-state laser or an ytterbium (Yb) doped fiber laser can be used as a light source 401. These light sources have high efficiency and a high-power. Consequently, a high-power coherent light source can be realized by a combination of these light sources and the wavelength conversion element 402, but further by maintaining a temperature of the wavelength conversion element 402 low, a highly efficient and high-power coherent light source 400 with the resistance of a high-power is realized.

When the wavelength of the fundamental wave is included in the range of 1030 nm to 1050 nm, as shown in FIG. 3B, the walk-off angle between the fundamental wave 404 and SFG 406 becomes smaller than 10 degrees, and SFG 406 is considerably strongly generated. Consequently, the resistance becomes 10 MW/square centimeter or less. In PPMgLN (wavelength conversion element 402), use in this region is desirably limited to the wavelength conversion of a low-power fundamental wave. In this time, a power density of the fundamental wave is desirably about 1 MW/square centimeter. In this fundamental wave wavelength region (1030 nm to 1050 nm), it is difficult to use such a constitution having high conversion efficiency (high-power light exists in the wavelength conversion element 402) that a high-power pulse is used as a fundamental wave or the wavelength conversion element 402 is used as an internal resonator, and in such applications, there is apprehension that the conversion efficiency is significantly decreased. In order to realize a stable output of the wavelength conversion element 402 (PPMgLN), it is desirable not to use this wavelength region (1030 nm to 1050 nm). In order to make use of this wavelength region, it is desirable to raise the temperature of a crystal (PPMgLN) to use it as shown in FIG. 6. The reason for this is that by raising the temperature of a crystal, it is possible to make the walk-off angle between a fundamental wave and SFG 10 degrees or more. Therefore, when such a wavelength region is used as a wavelength of a fundamental wave, an internal temperature of the wavelength conversion element 402 is, although depends on the wavelength of a fundamental wave, desired to be kept at about 100 to 150 degrees Celsius or higher.

Suitable applications of the wavelength conversion element 402 in the case where the wavelength of the fundamental wave is included in a range of 1060 nm to 1100 nm will be described. In this wavelength region (1060 nm to 1100 nm), a high-power light source using a neodymium (Nd) or ytterbium (Yb) doped solid-state light source can be utilized as a light source 401 of the fundamental wave. But, as shown in FIG. 3C, SFG 406 in an ultraviolet region, which is generated by quaternary QPM, exists. However, since the walk-off angle between the fundamental wave 404 and SFG 406 becomes 10 degrees or larger (15 degrees or larger in a range of 1070 nm or longer), the intensity of SFG 406 generation is kept at low level and the wavelength conversion element exhibits relatively high resistance. In this wavelength region (1060 nm to 1100 nm) of the fundamental wave, the resistance to a power density of a fundamental wave inputted exhibits about 50 MW/square centimeter or more. This is a low value compared with values of about 100 to 200 MW/square centimeter reported as the resistance to laser damage in usual LN, but in PPMgLN having a high nonlinear optical coefficient, it is a resistance which has no trouble with practical use since wavelength conversion can be performed with high efficiency of 50% or higher. In materials having low nonlinearity, a high power density of light is required for increasing efficiency and therefore a high resistance is required, but if PPMgLN is used in a wavelength range of 1060 nm to 1100 nm, a highly efficient and high-power coherent light source can be realized since a walk-off angle between the fundamental wave 404 and SFG 406 becomes 10 degrees or larger (15 degrees angle or larger in the range of 1070 nm or longer). And, in this wavelength region (1060 nm to 1100 nm), it is preferred from the viewpoint of a stable output to use a power density of about 50 MW/square centimeter or less of the fundamental wave. Further, it is more preferred to use a power density of about 1 to 40 MW/square centimeter. In this region, a high conversion efficiency of about 50% can be attained. Further, even if the wavelength conversion element is used for a long time, the degradation of crystal is not observed, and this element can have a long-life. And, in this wavelength region (1060 nm to 1100 nm), as shown in FIG. 6, it becomes possible to further improve the resistance by raising the temperature of a crystal. The reason for this is that since a walk-off angle between SFG and the fundamental wave increases, the generation of SFG is inhibited and the resistance is improved.

(Useful Life of Crystal Composing Wavelength Conversion Element)

A problem of the life of a crystal is closely related to increases in absorbed quantities of infrared light (for example, a fundamental wave 404) and visible light (for example, SHG 405) by a crystal (a wavelength conversion element 402) due to the generation of ultraviolet light (for example, SFG 406). If the wavelength conversion element is used for a long time in a state in which the absorption of a fundamental wave and the absorption of SHG are present due to the generation of ultraviolet light, crystal defects increase by the absorption of the fundamental wave and the visible light, and the conversion efficiency is reduced. Accordingly, even when by inputting a fundamental wave wavelength having a power below the resistance of the wavelength conversion element 402 into the element 402 which has a resistance capable of stably outputting on a short-term basis for use, it may be difficult to use stably for a long-term.

Therefore, it is preferred to set the walk-off angle between the fundamental wave 404 and SFG 406 at 10 degrees or larger in order to secure a long life of a crystal. The walk-off angle is more preferably set at 15 degrees or larger, and further when it is set at 20 degrees or larger, it is more preferred since the resistance can be enhanced to almost the same level as the resistance to the optical destruction. In order to secure the walk-off angle, it is preferred to control the temperature of a crystal to set a wavelength of phase matching at a desired value. Particularly when the fundamental wave wavelength is included in a range of 1060 nm to 1100 nm, SFG 406 is slightly exiting. Therefore, an output of SHG 405 is preferably restricted to below 5 watts to use the element. For example, the wavelength conversion element is preferably used by restricting the average output of SHG 405 to 1 watt or more, 2 watts or more, 2.5 watts or more, or 3.0 watts or more and 5.0 watts or less. When the wavelength conversion element is used in this SHG output range, highly efficient conversion and output stability, and a long life can be realized. And, when the element is used at higher power density, a crystal temperature may be elevated.

For the light source 401, a CW light source can be used, but a Q switch pulse light source is preferably used. The reason for this is that this pulse light source has a low average power of the fundamental wave 401 but it allows use of a high peak power and highly efficient conversion.

And, its cyclic frequency is preferably 1 kHz or higher. When the cyclic frequency is less than 1 kHz, a peak power may become too high. In order to limit the Q switch pulse light source to a power density of about 50 MW/square centimeter shown to be effective for stabilizing the coherent light source in accordance with the present invention to use it, the necessity to expand a beam spot of light and reduce an average power may arise.

Therefore, in order to use the Q switch pulse light source as a high-power light source, its cyclic frequency is preferably 1 kHz or higher, and more preferably 10 kHz or higher.

In addition, the light source 401 may have neodymium (Nd) materials such as Nd—YVO4, Nd—YAG and Nd-glass, or ytterbium (Yb) doped materials such as Yb—YAG and Yb-glass.

And, the light source 401 preferably include an Yb doped fiber laser.

The fiber laser is easy to increase in an output and has a high beam quality and excellent light-condensing characteristics and it can convert a wavelength with high efficiency. For example, if light from the light source of 100 watts is condensed to a spot of about 20 micrometer in diameter, a power density becomes about 30 MW/square centimeter and in some wavelengths of fundamental waves, a power density value which can have an effect on the resistance of the wavelength conversion element 402 (PPMgLN) can be attained. It becomes possible to output light at a high peak value having a high spiry peak value when Yb doped fiber laser is used as an amplifier and a light source 401 is constructed so as to amplify the light from the light source pulse-driven. Such light source 401 is suitable for realizing a highly efficient and high-power coherent light source. Further, when the wavelength conversion element 402 provided with an internal resonator structure is used, a power of a fundamental wave 404 within the resonator readily reaches several tens times or several hundreds times that of an external pump. Thus, an internal power is commonly 100 watts or larger. When the constitution of the coherent light source 400 of the present invention is applied, a highly efficient and stable visible light coherent light source of a high-power can be realized.

Further, in this embodiment, 5 mol % Mg doped PPMgLN is used as PPMgLN for the purpose of exemplification, but an amount of Mg used for doping of PPMgLN is desirably 4.9 mol % to 6 mol %. The reason for this is that PPMgLN having excellent resistance to optical damage is formed by this amount.

In addition to this, Zn, In, or Sc doped PPMgLN can also be used.

PPMgLN having the stoichiometric composition can be used because it is also a highly nonlinear material having excellent resistance to optical damage. In this case, an amount of Mg used for doping is preferably 1.5 mol % or more.

In addition, Mg doped LiTaO3, Mg doped stoichiometric LiTaO3, and KTP can be used for the wavelength conversion element 402 of the coherent light source 400 of the present invention. And, also in another highly nonlinear materials, particularly in the case where absorption of a crystal increases due to ultraviolet light, stable output characteristics can be realized if the walk-off angle between the fundamental wave 404 and SFG 406 is set at 10 degrees or larger. The walk-off angle is more preferably set at 15 degrees or larger.

The coherent light source of the present invention is a coherent light source which receives the fundamental wave from the light source and can allow a second harmonic of the fundamental wave to exit at a high-power. The output of the second harmonic can be an output of 1 watt or more in terms of an average output. And, it is also possible to attain the outputs of 2 watts or more, 2.5 watts or more, and 3 watts or more in terms of an average output.

### SECOND EMBODIMENT

### Output Instability Due to Absorption of Visible Light

The above-mentioned output instability due to a thermal lens effect is a phenomenon in which the absorption of the fundamental wave and the harmonics by the wavelength conversion element 402 occurs due to the generation of ultraviolet rays and the thermal lens effect is produced by the absorbed energy and the output is destabilized. When the infrared light is absorbed, an absorption coefficient is relatively small and therefore a power density required for producing the thermal lens effect is high. Therefore, the thermal lens effect is produced by a peak power having a high spiry peak value. On the other hand, an absorption coefficient is large and the thermal lens effect is produced more remarkably for visible light having a short wavelength.

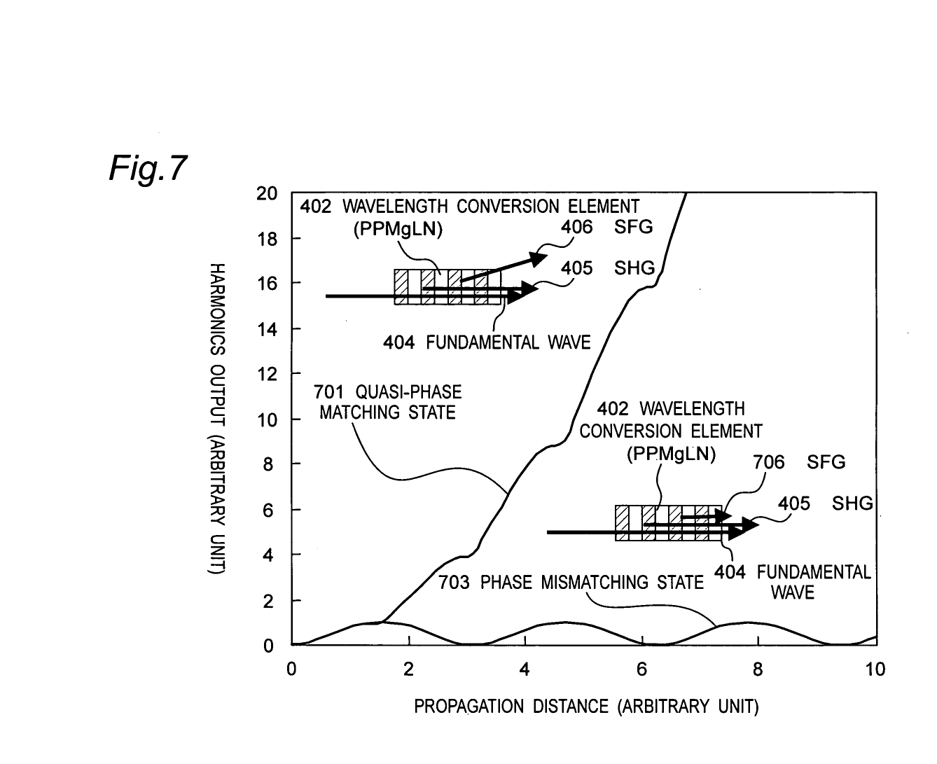

Further, the absorption also occurs by slight ultraviolet light for light having a wavelength of 600 nm or shorter. Therefore, the absorption of the harmonics occurs by a sum frequency (ultraviolet light) having a relatively low power. And, it was found that the absorption of the harmonics also occurs by SFG 706 not in phase matching besides SFG 406 in the above-mentioned quasi-phase matching. SFG 706 generated in a state of phase mismatching, which becomes a problem particularly at the time of generating CW light, will be described referring to FIG. 7. SFG 406 generated in the above-mentioned state of (quasi)-phase matching is generated forming a walk-off angle with the fundamental wave 404. In this case, an output 701 of SFG 406 increases with a distance of propagation (here, for simplicity, FIG. 7 is expressed by a state of primary quasi-phase matching but actually it includes a state of quasi-phase matching of higher order). On the other hand, SFG 706 in a state of phase mismatching propagates in the same direction as the fundamental wave 404 as shown in FIG. 7. An output 703 of SFG 706 in a state of phase mismatching hardly increases with a distance of propagation. However, it became apparent that the absorption also occurs by slight ultraviolet light (SFG 706) generated in a state of phase mismatching for light with a short wavelength.

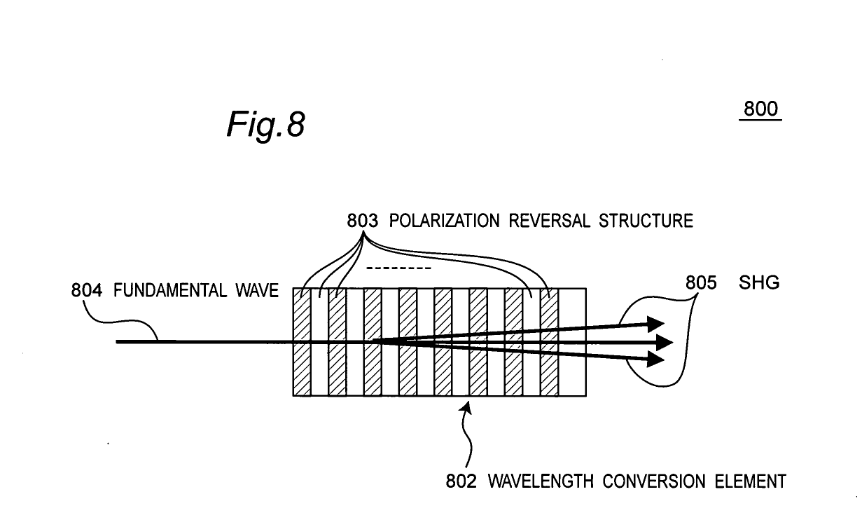

Here, a coherent light source which prevents the absorption of visible light by the wavelength conversion element 402 and exhibits a stable output characteristic will be described. The absorption of visible light also takes place by a sum frequency (SFG 706 and the like in FIG. 7) in which the phase matching condition does not hold. In order to prevent this, a structure for preventing the generation of a sum frequency is required. FIG. 8 is a constitution diagram of a wavelength conversion unit 800 of the coherent light source in accordance with the second embodiment of the present invention. Since another constitution sections may be similar to those of the first embodiment, explanations will be omitted.

### Wavelength Conversion Unit

Referring to FIG. 8, a fundamental wave 804 is converted to SHG (a second harmonic) 805 by wavelength conversion by a periodical polarization reversal structure 803 formed within a substrate (wavelength conversion element) 802. Here, a light source unit (not shown) includes a fiber laser and the wavelength of exiting light is 1084 nm. The fundamental wave 804 having a wavelength of 1084 nm is converted to green light having a wavelength of 542 nm by wavelength conversion by PPMgLN (the wavelength conversion element 802) having the periodical polarization reversal structure 803. Here, the period of the periodical polarization reversal structure 803 is about 7 micrometer and the condition of a phase matching is controlled through a temperature control of the element 802. The temperature control may include a temperature control section (not shown).

When the condition of perfect phase matching is satisfied, the fundamental wave 804 and SHG 805 propagate in the same direction. In this embodiment, a state of phase mismatching is maintained by deviating a temperature of the wavelength conversion element 802 from a temperature of the state of the perfect phase matching.

For this purpose, SHG 805 exits at a given angle (walk-off angle) relative to the fundamental wave 804. In doing so, the efficiency of conversion to SHG 805 is reduced, but an output of a sum frequency generated by the fundamental wave 804 and SHG 805 is significantly reduced since the overlap of beams of the fundamental wave 804 and SHG 805 decreases. Thereby, the phenomenon of an output to be destabilized due to the absorption of SHG 805 is extensively reduced.

By deviating the constitution of the wavelength conversion element 802 from the phase matching condition and using the element 802, a walk-off angle of non-zero is generated to suppress the generation of the sum frequency.

### MODIFICATION EXAMPLE

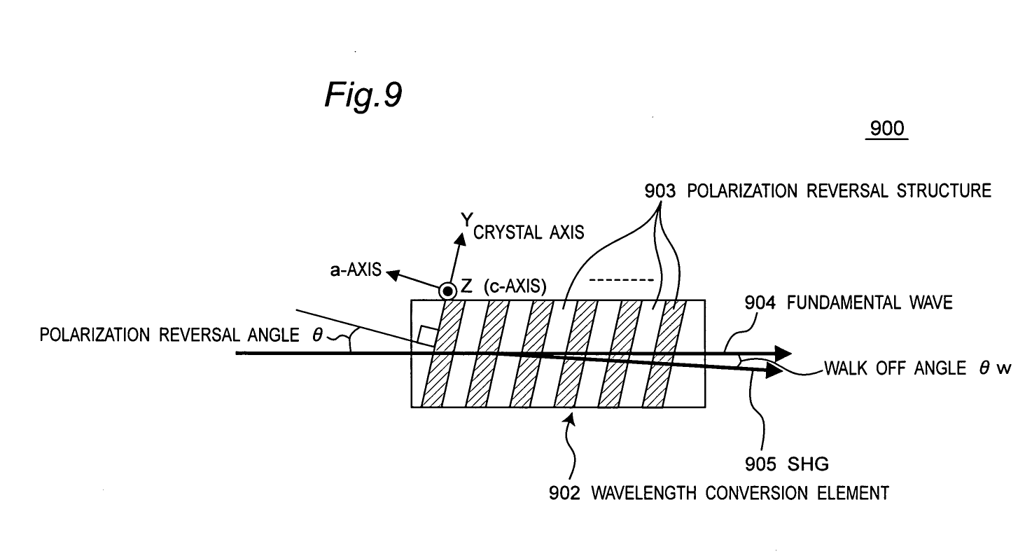

FIG. 9 is a constitution diagram of a wavelength conversion unit 900 in accordance with a modification example of the second embodiment of the present invention. Here, a wavelength conversion element is formed with the normal direction of a stripe of a polarization reversal structure 903 inclined by an angle of theta relative to an optical axis of a fundamental wave 904. Thereby, a walk-off angle theta_W is provided between SHG 905 and the fundamental wave 904 through chromatic dispersion of SHG 905 and the fundamental wave 904. An angle which an optical axis of polarization reversal forms with the fundamental wave 904 is assumed to be a polarization reversal angle. In the case of the constitution shown in FIG. 8, since SHG 805 output is separated into two directions, the decrease in conversion efficiency due to the generation of a walk-off angle of non-zero is relatively large. However, when the wavelength conversion element 902 is constructed as shown in FIG. 9, it is possible to adjust an angle at which SHG 905 is generated, namely, a walk-off angle theta_W by an inclined angle of the polarization reversal structure 903. And, since a propagating direction of SHG 905 is limited to one direction, the decrease in the conversion efficiency can be reduced. And, by realizing a walk-off angle theta_W of non-zero, the overlap of the fundamental wave 904 and SHG 905 decreases and therefore a sum frequency (SFG) generated by this overlap can be significantly reduced to improve the stability at the time of a high output.

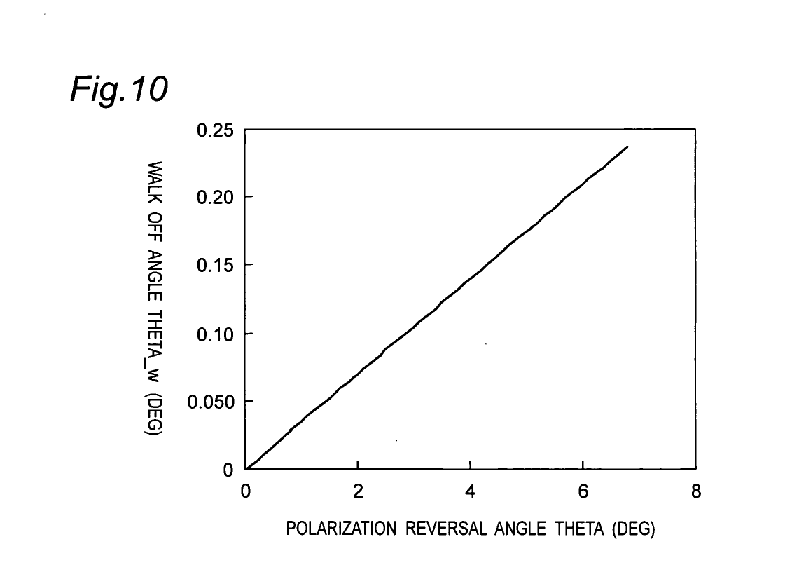

FIG. 10 is a graph showing a relationship between a polarization reversal angle theta (an angle by which the polarization reversal structure 903 deviates from the state perpendicular to a beam of the fundamental wave) and a walk-off angle which the fundamental wave 904 forms with SHG 905. This graph is derived by calculation assuming that the wavelength of the fundamental wave is 1080 nm. Referring to FIG. 10, it is apparent that the walk-off angle theta_W is about 30 times smaller than the polarization reversal angle theta of the polarization reversal structure 903. The walk-off angle needs to be kept at 0.1 degrees angle or more in order to suppress the generation of the harmonics. Therefore, it is preferred to have a polarization reversal angle theta of 3 degrees or more.

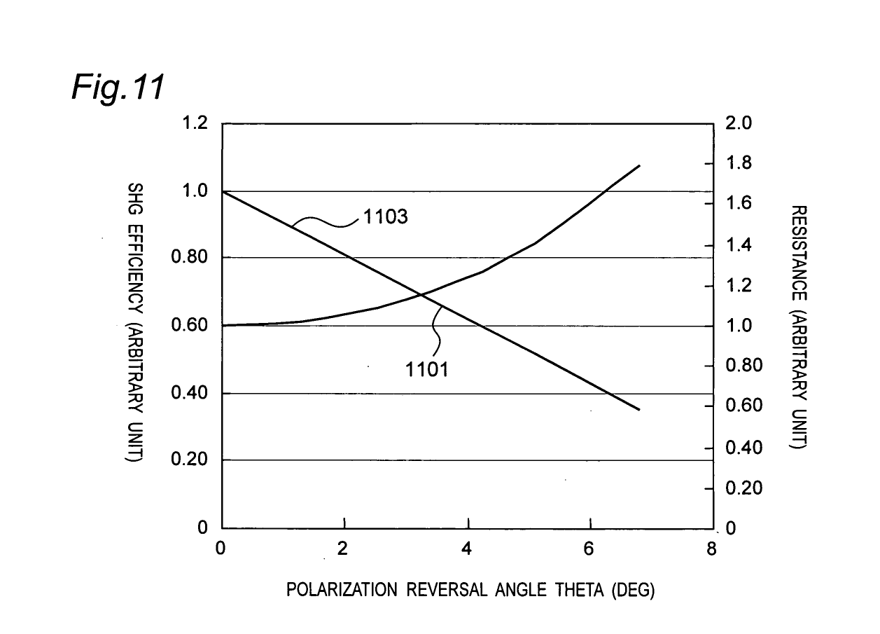

FIG. 11 is a graph showing relationships between the polarization reversal angle theta and the efficiency 1101 of conversion of the fundamental wave 904 to SHG 905 and between the polarization reversal angle theta and the resistance 1103 of a high-power of the wavelength conversion element 902. When the polarization reversal angle is 2 degrees angle or more, remarkable improvement in the resistance is found. When the polarization reversal angle is 5 degrees angle, the resistance of a high-power is 1.4 times larger than that at the polarization reversal angle 0 degree and the conversion efficiency is reduced to about one half.

Since the conversion efficiency drops with increases in angle of the polarization reversal structure 903, the polarization reversal angle is preferably 3 degree or more and 20 degrees angle or less. The polarization reversal angle is more preferably 5 degrees angle or more and 10 degrees angle or less.

Referring to FIG. 9 again, the direction of a stripe of the polarization reversal structure 903 is set so as to be in parallel with the direction of a Y-axis (the direction perpendicular to an a-axis and a c-axis of a crystal, here, a Z-axis is in parallel with the c-axis and an X-axis is in parallel with the a-axis) of a crystal substrate composing the wavelength conversion element 902. The polarization reversal structure 903 of a bulk crystal is preferably formed in a Z substrate. An electrode is formed on the +Z surface of the Z substrate and a voltage is applied to this electrode. In this case, the direction of a stripe of the electrode needs to be almost conformed to the direction of the Y-axis of a crystal composing the element 902 to be formed. Accordingly, when the polarization reversal structure 903 is formed being angled relative to an optical axis, the Y-axis of a crystal is preferably formed being inclined to the optical axis. When the direction of a stripe of the polarization reversal structure 903 is deviated from the Y-axis of a crystal, uniformity of the polarization reversal structure 903 is deteriorated and the conversion efficiency is significantly reduced. Therefore, the stripe of the polarization reversal structure 903 is preferably conformed with the Y-axis direction. An angle between the polarization reversal structure 903 and the Y-axis is preferably restricted to 1 degree or less. If this angle is larger than 1 degree, efficiency is reduced to 80% or less compared with the case where the polarization reversal structure 903 is formed in an ideal direction due to the nonuniformity of the polarization reversal structure 903. When the deviation of the stripe of the polarization reversal structure 903 from the Y-axis is 5 degrees angle or more, conversion efficiency is reduced to less than half of the ideal state.

Further, in this embodiment, the case of generating SHG 805 or 905 from a fundamental wave 804 or 904 is described, but also when a sum frequency is generated from two fundamental waves, a phenomenon of destabilization of an output may arise due to the absorption of the sum frequency.

For example, when a sum frequency with a wavelength of 450 nm is generated from a fundamental wave with a wavelength of 1080 nm and a fundamental wave with a wavelength of 770 nm, the thermal lens effect is produced in a wavelength conversion element due to the absorption of the sum frequency with a wavelength of 450 nm by the wavelength conversion element. In this case, ultraviolet light to cause the absorption is generated due to ultraviolet light with a wavelength of 385 nm, which is a second harmonic of the fundamental wave with a wavelength of 770 nm.

In this case, it is preferred to conform optical axes of two fundamental waves to each other and to allow the sum frequency with a wavelength of 450 nm to exit at a different angle. Or, a constitution, in which two optical axes of the fundamental wave with a wavelength of 1080 nm and the sum frequency with a wavelength of 450 nm are conformed to each other and the optical axis of the fundamental wave with a wavelength of 770 nm is slightly inclined to the above-mentioned two lights, is preferred. By providing a walk-off angle between the fundamental wave and the sum frequency, it is possible to reduce the generation or the influence of ultraviolet light and to improve the resistance of a high-power. And, when the sum frequency is generated, it also becomes possible to improve the resistance of a high-power by the power ratio of two fundamental waves. When the sum frequency is generated from two fundamental waves having different wavelengths, an output of the sum frequency is proportional to the product of powers of two fundamental waves. On the other hand, in SHG generated from the fundamental wave which causes the absorption of the sum frequency, SHG generated from the fundamental wave with a short wavelength causes a problem. Thus, in the case where the sum frequency is generated, it is preferred to select a power P1 of a first fundamental wave with a wavelength of lambda1 and a power P2 of a second fundamental wave with a wavelength of lambda2 so as to be P1>P2 in the case of lambda1>lambda2. By reducing a power of light with a shorter wavelength, the generation of SHG with a shorter wavelength is further reduced and the resistance of a high-power can be improved.

In addition, as the light source unit composing the coherent light source in accordance with this embodiment, the light sources shown in other embodiments can be used.

### THIRD EMBODIMENT

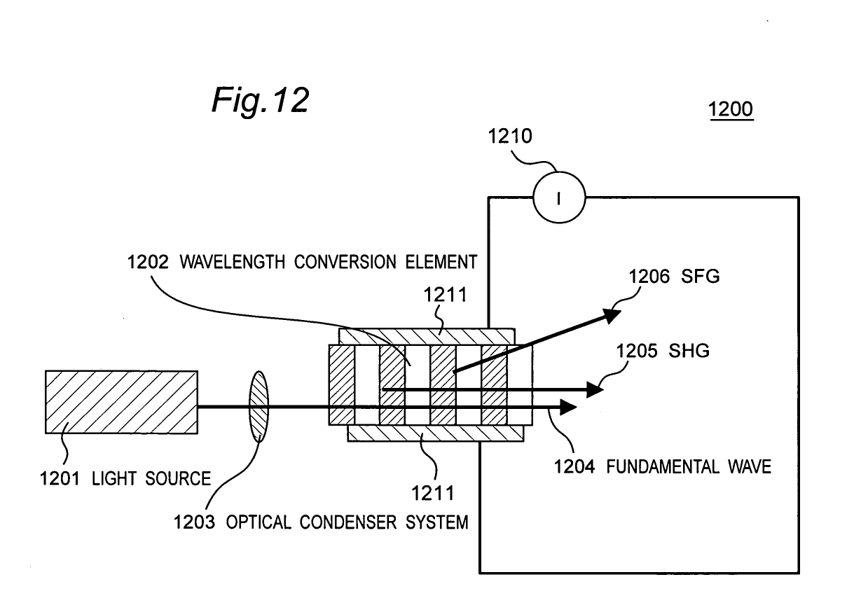

Here, a constitution of a coherent light source 1200 in accordance with the third embodiment of the present invention will be described. FIG. 12 is a diagram showing a constitution of a coherent light source 1200 of the third embodiment. The coherent light source 1200 of the present embodiment has a constitution similar to that shown in the previous embodiment, but is different from that in accordance with the previous embodiment in that it has a power supply 1210 and an electrode 1211 located in a wavelength conversion element 1202. As with the previous embodiment, a fundamental wave 1204 exiting a light source 1201 is converted to SHG 1205 by the wavelength conversion element 1202 (PPMgLN). Further, SHG 1205 and the fundamental wave 1204 may generate a sum frequency and SFG 1206 may be produced. When SFG 1206 is light in an ultraviolet light region with a wavelength of 400 nm or shorter, number of free electrons increases within PPMgLN due to ultraviolet rays generated. By applying a voltage to the wavelength conversion element 1202 through the electrode 1211, it is possible to transfer a charge to reduce the absorption of SHG 1205. The voltage applied to the electrode 1211 preferably varies in the form of alternating current and application of volts alternating current with a frequency of 100 Hz or higher is desirable.

### INDUSTRIAL APPLICABILITY

As described above, the inventor of the present invention reveals a mechanism of a heretofore undissolved phenomenon of an output to be destabilized in converting SHG by wavelength conversion and thereby provides a coherent light source which can suppress the generation of a sum frequency and attain a stable output of a second harmonic.

The coherent light source of the present invention can suppress the generation of the sum frequency and attain a stable output of the second harmonic by increasing a walk-off angle between the sum frequency light generated by the fundamental wave and the second harmonic and a fundamental wave.

Further, by providing a walk-off angle between the fundamental wave and the second harmonic, it is possible to suppress the generation of the sum frequency to improve the resistance of a high-power. The coherent light source of the present invention has large practical effects as a coherent light source for high-power applications.

Further, also in a coherent light source having a constitution of generating a sum frequency from two fundamental waves, the resistance of a high-power is improved by providing a walk-off angle between the fundamental wave and the sum frequency. Practical effects of such a coherent light source are also extremely large.

1-18. (canceled)

19. A coherent light source, comprising:
a light source unit that allows a fundamental wave having a wavelength of 1070 nm to 1100 nm to exit; and
a wavelength conversion unit that receives the fundamental wave from said light source unit and allows a second harmonic of said fundamental wave and a sum frequency of the fundamental wave and the second harmonic to exit and includes a LiNbO3 substrate with a periodical polarization reversal structure, doped with at least any one of Mg, Sc, In, and Zn, and
wherein said light source unit restricts the intensity of the fundamental wave exiting based on a value of an angle theta which an exiting beam of the sum frequency forms with an exiting beam of the fundamental wave.

20. The coherent light source according to claim 19, wherein said light source unit restricts the intensity of the fundamental wave to 10 MW/square centimeter or less when the angle theta is less than 10 degrees.

21. The coherent light source according to claim 19, wherein said light source unit restricts the intensity of the fundamental wave to 50 MW/square centimeter or less when said angle theta is more than 10 degrees and less than 15 degrees.

22. The coherent light source according to claim 19, wherein said wavelength conversion unit includes a periodical polarization reversal structure and includes LiNbO3 doped with Mg in an amount of 5 mol % or more.

23. The coherent light source according to claim 19, wherein said wavelength conversion unit is operated at a temperature of 100 degrees Celsius or lower.

24. The coherent light source according to claim 19, further comprising an ultraviolet light shielding unit that covers at least a part of said wavelength conversion unit to protect said wavelength conversion unit from light with a wavelength of 400 nm or shorter entering from the outside.

25. A coherent light source, comprising:
a light source unit that allows a fundamental wave having any wavelength of 800 nm or longer to exit;
a wavelength conversion unit that receives the fundamental wave and allows a second harmonic of the first wavelength to exit; and
an ultraviolet light shielding unit that covers at least a part of said wavelength conversion unit to protect said wavelength conversion unit from light with a wavelength of 400 nm or shorter entering from the outside.

26. The coherent light source according to claim 19, further comprising:
an electrode unit located in such a way that a current can be passed through said wavelength conversion unit; and
a power supply unit to apply a voltage to said electrodes.

27. The coherent light source according to claim 19, wherein said light source unit includes a fiber laser.

28. The coherent light source according to claim 19, wherein said light source unit is pulse-driven by a Q switch and a cyclic frequency of the Q switch is 1 kHz or higher.

29. The coherent light source according to claim 19, wherein said wavelength conversion unit can allow the second harmonics to exit at an average output of 1 watt or more.

30. The coherent light source according to claim 19, wherein said wavelength conversion unit can allow the second harmonics to exit at an average output of 2 watts or more.

31. The coherent light source according to claim 19, wherein said wavelength conversion unit can allow the second harmonics to exit at an average output of 2.5 watts or more.

32. The coherent light source according to claim 19, wherein said wavelength conversion unit can allow the second harmonics to exit at an average output of 3 watts or more.

33. The coherent light source according to claim 19 wherein an amount of the dope with at least any one of Mg, Sc, In, and Zn is within a range of 4.9 mol % to 6.0 mol %.

34. The coherent light source according to claim 19 wherein the fundamental wave exited from said light source unit enters said wavelength conversion unit such that an optical axis of the fundamental wave forms a substantially non-zero angle to a normal of a stripe of the polarization reversal structure.
